(19) United States
(12) Patent Application Publication
(10) Pub. No.: US 2012/0096207 A1
(43) Pub. Date: Apr. 19, 2012

(54) OPERATING MODE CONTROL FOR PORTABLE DEVICE

(75) Inventor: Johnny Chen, Santa Ana, CA (US)

(73) Assignee: I O INTERCONNECT, LTD., Santa Ana, CA (US)

(21) Appl. No.: 13/340,666

(22) Filed: Dec. 29, 2011

Related U.S. Application Data
(63) Continuation-in-part of application No. 13/007,657, filed on Jan. 16, 2011.
(60) Provisional application No. 61/388,587, filed on Sep. 30, 2010.

(51) Int. Cl. G06F 13/00; H02J 7/00

(52) U.S. Cl. 710/303; 320/115

(57) ABSTRACT

An embodiment of the invention provides an operating mode setting method for a portable device. The method includes: connecting the portable device to a dock; acquiring an ID of the dock; and changing an operating mode of the portable device to a first mode corresponding to the ID.

### CROSS REFERENCE TO RELATED APPLICATIONS

This application claims the benefit of U.S. Provisional Application No. 61/388,587 filed 2010, Sep. 30 and entitled “Communication Apparatus and Signal and/or Data Transmission Method”. The entire contents of which are hereby incorporated by reference.

This application is a Continuation-In-Part of application Ser. No. 13/007,657, filed Jan. 16, 2011, the entirety of which is incorporated by reference herein.

### BACKGROUND OF THE INVENTION

1. Field of the Invention

The present invention relates to a portable device, and more particularly to a portable device that can automatically change its operating mode or status when connecting to a dock.

2. Description of the Related Art

Portable electronic devices have become a necessity for consumers both for personal and business use. Most of the portable devices provide different operating modes and users can select one appropriate operating mode according to different scenarios. For example, some portable electronic devices may provide alert signals to a user indicating an incoming call, incoming text message, incoming short message service (SMS), alarm clock, etc. The alert signal comprises various types, for example, a ring tone and/or a mechanical vibration. When a user is at a meeting, the mechanical vibration is preferred over the ringtone. However, if the user forgets to manually disable the ringtone and only enable the mechanical vibration, the meeting may be interrupted and participants may be upset.

### BRIEF SUMMARY OF THE INVENTION

An embodiment of the invention provides an operating mode setting method for a portable device. The method comprises: connecting the portable device to a dock; acquiring an ID of the dock; and changing an operating mode of the portable device to a first mode corresponding to the ID.

Another embodiment of the invention provides a dock comprising a connector and a memory device. The connector connects to a portable device. The memory device stores a dock ID. When the portable device is connected to the dock, an application program is executed and changes a current operating mode of the portable device to a first mode according to the dock ID.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a schematic block diagram of a communication apparatus according to an embodiment of the invention.

FIG. 2 a schematic diagram of an exemplary communication system according to an embodiment of the invention.

FIG. 3 shows another schematic diagram of a communication system according to another embodiment of the invention

FIG. 4 shows a flow chart of a signal processing method for processing a plurality of signals of a portable electronic device according to an embodiment of the invention.

FIG. 5 is a block diagram showing an electronic system including a portable device and a dock according to an embodiment of the invention.

FIG. 6 is a block diagram showing an electronic system including a portable device and a dock according to another embodiment of the invention.

FIG. 7 is a flowchart of an operating mode setting method according to an embodiment of the invention.

FIG. 8 is a schematic diagram of a dock according to an embodiment of the invention.

FIG. 9 is a schematic diagram of an operating mode setting according to an embodiment of the invention.

FIG. 10 is a flowchart of an operating mode setting method according to another embodiment of the invention.

FIG. 11 is a block diagram showing an electronic system including a portable device and a dock according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

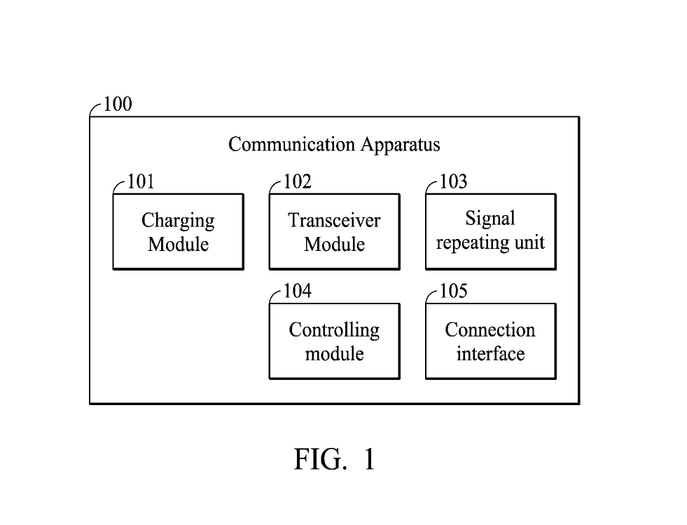

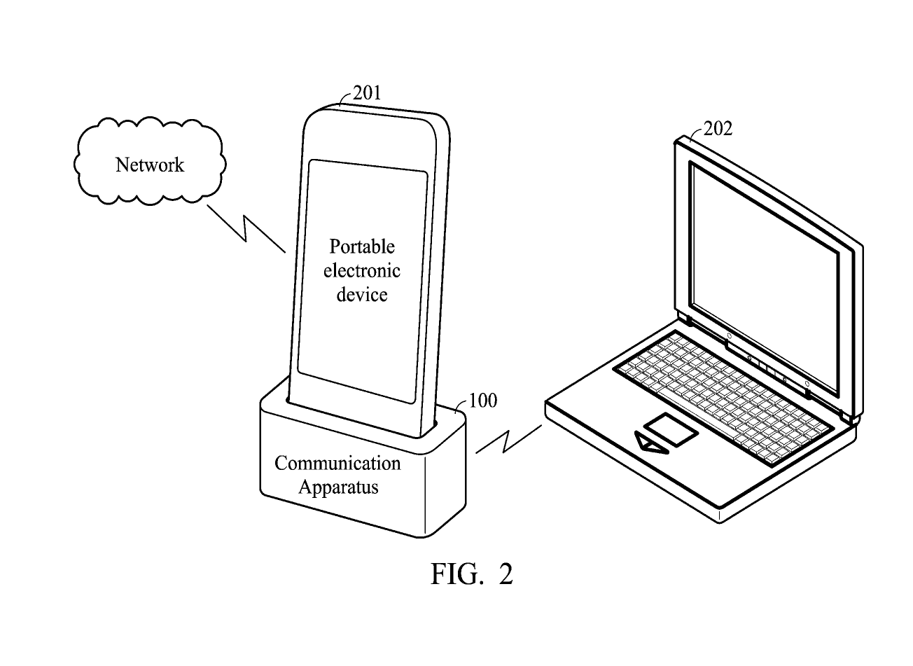

FIG. 1 shows a schematic block diagram of a communication apparatus according to an embodiment of the invention. The communication apparatus 100 may at least comprise a charging module 101, a transceiver module 102 and a signal repeating unit 103. The charging module 101 is arranged to provide a charging function to charge up a portable electronic device (such as the portable electronic device 201 shown in FIG. 2). The transceiver module 102 is arranged to receive a plurality of signals from the portable electronic device and transmit a plurality of enhanced signals to an air interface. The signal repeating unit 103 is arranged to receive the signals and enhance the signals to generate the enhanced signals. In one embodiment of the invention, the signal repeating unit 103 may comprise a power amplifier to enhance level or power of the signals. Note that the signal repeating unit 103 may directly receive the signals from the portable electronic device 201, or receive the signals of the portable electronic device 201 from the transceiver module 102, and the invention should not be limited thereto. In addition, in some embodiments of the invention, the signal repeating unit 103 may also be comprised by the transceiver module 102, and the invention should not be limited thereto.

According to an embodiment of the invention, the communication apparatus 100 may be a charging dock capable of providing a charging function for portable electronic devices. One or more electronic devices may be electrically connected to the communication apparatus for battery charging. The charging module 101 may receive electric power from a power source and use the electric power to charge up the portable electronic devices. Note that the electric connection may be presented in either a wired or wireless manner, and the invention should not be limited to either case. For example, in one embodiment of the invention, the communication apparatus 100 may be connected to the portable electronic device via a connection interface 105 as shown in FIG. 1, so as to provide the electric power through the connection interface 105 to charge up the portable electronic device. Note that the connection interface may be implemented as a tangible connector to directly connect to the portable electronic devices. However, the connection interface may also be implemented as a communication interface facilitating a wireless connection established between the communication apparatus and the portable electronic devices. Therefore, the charging module 101 may directly charge up the portable electronic device or wirelessly charge up the portable electronic device through the air interface and the invention should not be limited to either cases.

FIG. 2 shows a schematic diagram of an exemplary communication system according to an embodiment of the invention. Note that the drawings illustrate the communication apparatus with a portable electronic device and a computer. However, the present innovation should not be limited thereto. When a portable electronic device 201 (or multiple portable electronic devices, and the present innovation is not limited thereto) is electrically connected to the communication apparatus 100, the communication apparatus 100 may act as a repeater to receive signals from the portable electronic device 201, enhance the signals and transmit the enhanced signals to the air interface. According to an embodiment of the invention, the signals may be transmitted from the portable electronic device 201 to the communication apparatus 100 via the electric connection therebetween. The electric connection may be presented in either a wired or wireless manner, and the invention should not be limited thereto. For example, the signals may be transmitted from the portable electronic device 201 to the communication apparatus 100 via the wire or the pins of a connector connected therebetween, or may be wirelessly transmitted from the portable electronic device 201 to the communication apparatus 100.

According to an embodiment of the invention, the portable electronic device 201 may be equipped with a predetermined communication module to provide a predetermined wireless communications service in compliance with a predetermined protocol. When the communication apparatus 100 is electrically connected to (either in a wired or a wireless manner) the portable electronic device 201, a new function of providing network access services, such as being like a hotspot or access point, may be achieved. A peer electronic device 202, such as a notebook shown in FIG. 2, may establish a wireless connection with the portable electronic device 201. For example, the transceiver module 102 may transmit the enhanced signals to the peer electronic device 202 through the air interface so as to facilitate a wireless connection established between the portable electronic device 201 and the peer electronic device 202. Having the wireless connection established therebetween, the communication apparatus 100 and the portable electronic device 201 may further act as a hotspot (or so-called access point) to facilitate the peer electronic device 202 to connect to an internet therethrough.

For example, when the portable electronic device 201 is equipped with a WiFi communication module, the WiFi signals generated by the portable electronic device 201 for providing communication service and/or Network access function may be passed to the communication apparatus 100, repeated and then transmitted by the communication apparatus 100 to the air interface. The peer electronic device 202 may receive the WiFi signals transmitted by the communication apparatus 100 from the air interface, and use the communication service and/or connect to the Network via the portable electronic device 201 and the communication apparatus 100.

For another example, when the portable electronic device 201 is equipped with a UMTS communication module, the 3G signals generated by the portable electronic device 201 for providing a communication service and/or Network access function may be passed to the communication apparatus 100, repeated and then transmitted by the communication apparatus 100 to the air interface. The peer electronic device 202 may receive the 3G signals from the air interface, and use the communication service and/or connect to the Network via the portable electronic device 201 and the communication apparatus 100.

Note that in the embodiments of the invention, even if the portable electronic device 201 is not charged by the communication apparatus 100, as long as the portable electronic device 201 is electrically connected to the communication apparatus 100, the signals may be transmitted therebetween. In other words, the communication apparatus 100 and the portable electronic device 201 may act as a hotspot or an access point regardless of whether the portable electronic device 201 is being charged by the communication apparatus 100.

According to an embodiment of the invention, the communication apparatus 100 may further comprise a controlling module 104 as shown in FIG. 1 for controlling the signal received from and/or transmitted to the portable electronic device. The controlling module 104 may be a controller chip controlling the transceiver module to extract the signals from the portable electronic device 201, and/or direct the signals received from the air interface to the portable electronic device 201. Note also that according to yet another embodiment of the invention, the controlling module 104 may also be implemented in the side of the portable electronic device and the innovation should not be limited thereto. For example, the controlling module may be as a software application function installed therein for controlling the signals to be transmitted to and/or received from the communication apparatus 100.

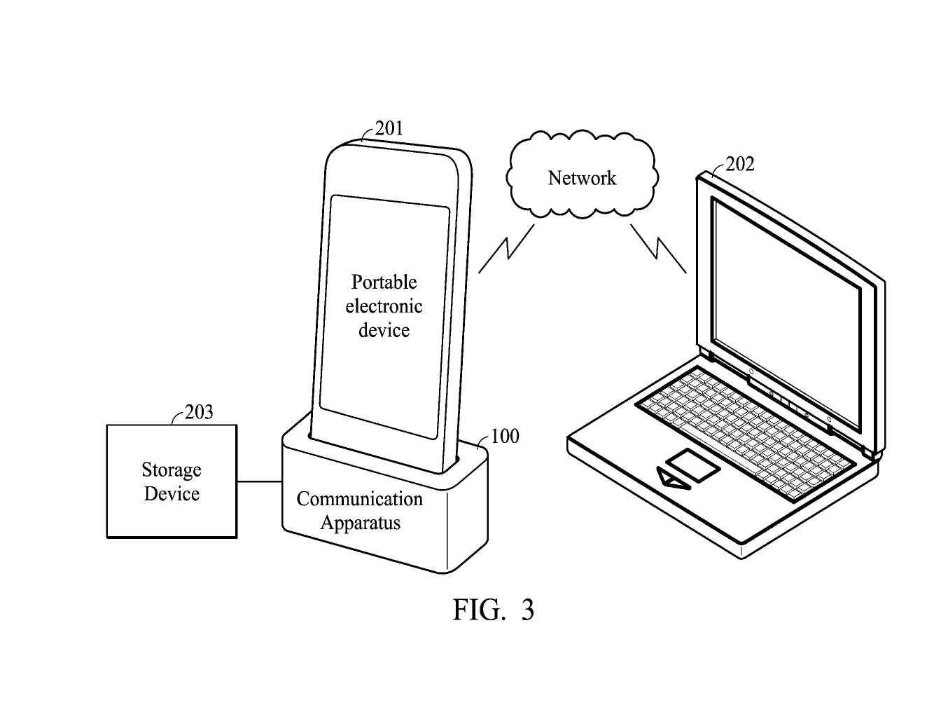

FIG. 3 shows another schematic diagram of a communication system according to another embodiment of the invention. In the aspect of the invention, the communication apparatus 100 may further be electrically connected to a storage device 203, and integrated with the storage device 203 as a NAS (network attached storage) system. Network attached storage (NAS) is a file-level data storage device connected to a Network for providing data access to heterogeneous clients. According to an embodiment of the invention, the communication apparatus 100 may be equipped with a connector, such as a USB port, to electrically connect to the storage device 203. Because, as previously described, the communication apparatus 100 may act as a repeater or hotspot, along with the portable electronic device 201 to provide communication service and/or Network access function, the communication apparatus 100 may further be a NAS when a storage device 203 is electrically connected thereto.

A peer electronic device 202, such as a notebook shown in FIG. 3, that is connecting to the Network and using the communication service 100 via the portable electronic device 201, may further access the data stored in the storage device 203. For example, the peer electronic device 202 may issue a data access request for wireless access of data through the communication apparatus 100. The transceiver module 102 may transmit the data stored in the storage device 203 to the air interface in response to the data access request received from the portable electronic device 201, which has a wireless connection with the peer electronic device 202 as previously described. Note that in some embodiments, the data access request may be transmitted from the peer electronic device 203 to the portable electronic device 202, or directly to the communication apparatus 100, and the invention should not be limited thereto. Note also that in some embodiments, the storage device may also be a built-in storage device inside of the communication apparatus 100, and the invention should not be limited thereto.

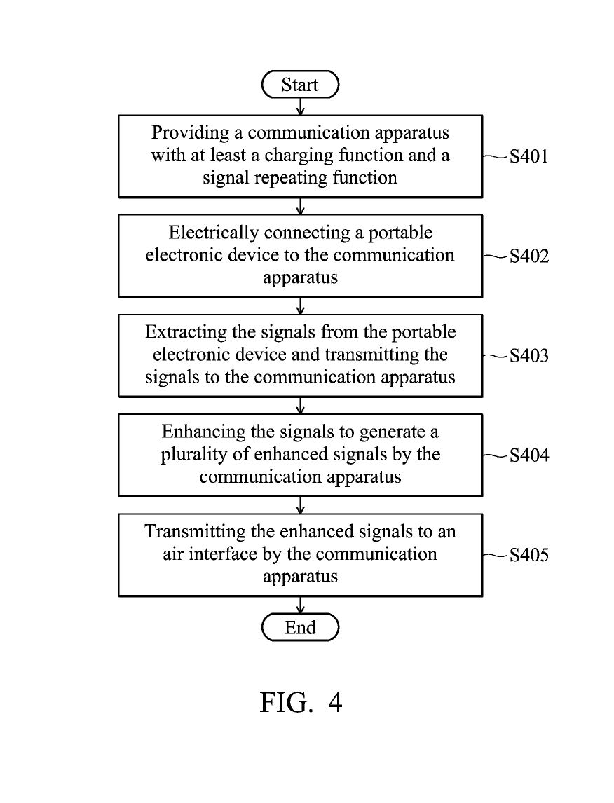

FIG. 4 shows a flow chart of a signal processing method for processing a plurality of signals of a portable electronic device according to an embodiment of the invention. A communication apparatus with at least a charging function and a signal repeating function is first provided (Step S401). Next, the portable electronic device is electrically connected to the communication apparatus (Step S402). Next, the signals are extracted from the portable electronic device and transmitted to the communication apparatus (Step S403). Next, the signals are enhanced to generate enhanced signals by the communication apparatus (Step S404). Finally the enhanced signals are transmitted to an air interface by the communication apparatus (Step S405), so as to facilitate a wireless connection established between the portable electronic device and a peer electronic device.

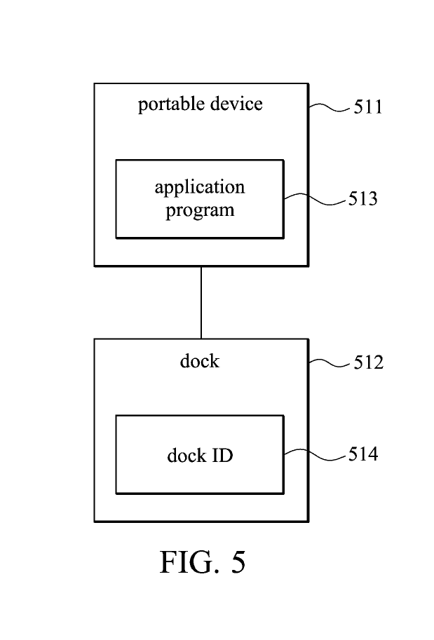

FIG. 5 is a block diagram showing an electronic system including a portable device and a dock according to an embodiment of the invention. The dock 512 has a dock ID 514. The dock ID 514 may be an ID of one element of the dock 512 or given by a vendor when manufacturing. When the portable device 511 is connected to the dock 512, an application program 513 first identifies and acquires the dock ID 514, and then changes the operating mode according to the dock ID 514. In another embodiment, when the dock 512 detects that the portable device 511 is connected to the dock 512, the dock 512 directly transmits the dock ID 514 to the portable device 511. The operating mode comprises settings a plurality of control parameters, such as sound, vibration, notification, etc. For example, when the dock 512 is placed in a bedroom, the application program 513 switches the portable device 511 to a silent mode so that the functions of sound alert or vibration are all disabled. When the dock 512 is placed in an office, the application program 513 switches the portable device 511 to an office mode so that the functions of all sound alerts are enabled and the volume is increased. According to the described paragraph, the application program 513 can auto-change the operating mode of the portable device 511 according to the dock ID 514. The application program 513 can identify the current location of the portable device 511, such as bedroom, office or meeting room, according to the dock ID 514. In other words, the dock ID 514 can be regarded as a parameter indicating the location for the portable device 511.

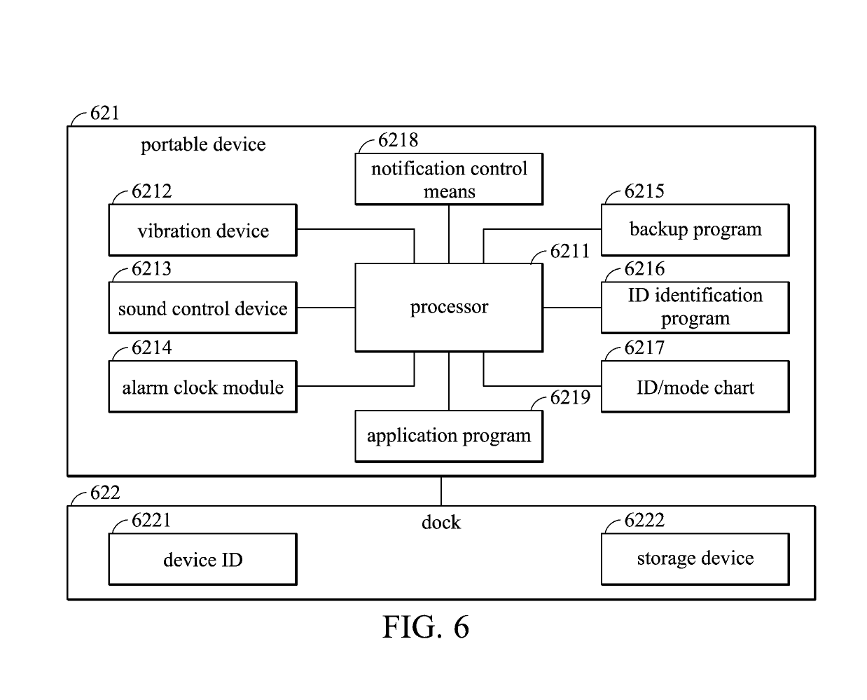

FIG. 6 is a block diagram showing an electronic system including a portable device and a dock according to another embodiment of the invention. The portable device 621 comprises a processor 6211, a vibration device 6212, a sound control device 6213, an alarm clock module 6214, a backup program 6215, an ID identification program 6216, a comparison chart of ID and mode 6217, a notification control means 6218 and an application program 6219. The dock 622 physically connects to the portable device 621 via a connector, slot or socket. The dock 622 comprises a device ID 6221 stored in a memory device and a storage device 6222. When the portable device 621 is connected to the dock 622, the ID identification program 6216 is first executed to find and transmit the device ID 6221 to the processor 6211. The processor 6211 then searches the comparison chart 6217 to find a corresponding mode. The application 6219 then controls the vibration device 6212, the sound control device 6213, the alarm clock module 6214, the backup program 6215 and then the notification control means 6218 according to the corresponding mode.

The vibration device 6212 mechanically vibrates the portable device 621 according to an alert signal and thus provides a relatively silent or less obtrusive alert signal as compared to the ringtone. The sound control device 6213 controls the sound of the portable device 621. When the sound control device 6213 is disabled, the portable device 621 cannot make sounds anymore. The sound control device 6213 can also adjust the volume of a speaker. The backup program 6215 is used to back up the data of the portable device 621 to the storage device 6222. In another embodiment, the backup program 6215 backs up the data of the portable device 621 to a third party, such as a backup server, via the dock 622. The notification control device 6218 determines whether the notification function is enabled or disabled. It is noted that the notification control device 6218 controls various kinds of notifications, and can only be set to be turned ON or turned Off. The notification control device 6218 cannot control each notification corresponding to individual application programs. Another notification manager program is provided for setting the notification of each application program.

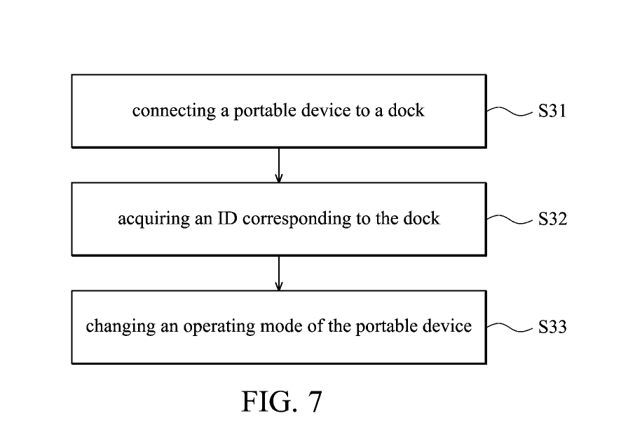

FIG. 7 is a flowchart of an operating mode setting method according to an embodiment of the invention. In step S31, the portable device is connected to a dock directly or via a connection cable. In step S32, the portable device acquires an ID of the dock. The ID may be a product ID of the dock. In step S33, the operating mode of the portable device is changed according to the ID. The operating mode of the portable device comprises the settings of a plurality of parameters. The user can set different operating modes according to the location of the dock.

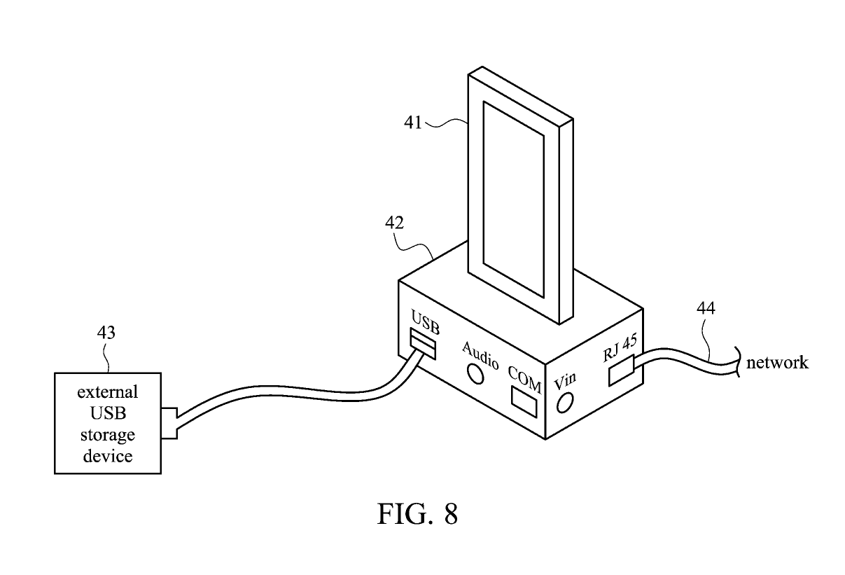

FIG. 8 is a schematic diagram of a dock according to an embodiment of the invention. The dock 42 comprises a slot for connecting to the portable device 41. The dock 42 comprises a plurality of types of connectors to increase the expandability of the portable device 41. The dock 42 comprises a USB port for connecting to a USB device, such as an external USB storage device 43. The portable device 41 can back up its data to the external USB storage device 43. The dock 42 comprises a network connector for connecting to a network cable 44. If the dock 42 is connected to the Internet, then, the dock 42 can share the network function with the portable device 41. In other words, the portable device 41 can therefore connect to the Internet via the dock 42. When the portable device 41 connects to the Internet, the portable device 41 can back up its data to a backup server via the network. The dock 42 comprises a power input jack and when an adapter or an external battery device connects to the power input jack, the portable device 41 can be charged. In another embodiment, the dock 42 comprises a built-in charging device to charge the portable device 41. The built-in charging device is connected to an AC voltage source and transforms an AC voltage into a DC voltage required by the portable device. The dock 42 comprises an audio output jack for connecting to an earphone or a speaker. The dock 42 further comprises a COM port that can connect to a projector. In one embodiment, assuming the dock 42 is placed in a meeting room, when the portable device 41 is connected to the dock 42, a control device of the dock 42 first search files with a specific format in a specific folder of the portable device 41. When the control device finds a matching file in the specific folder, the matching file is then transmitted to the projector for display.

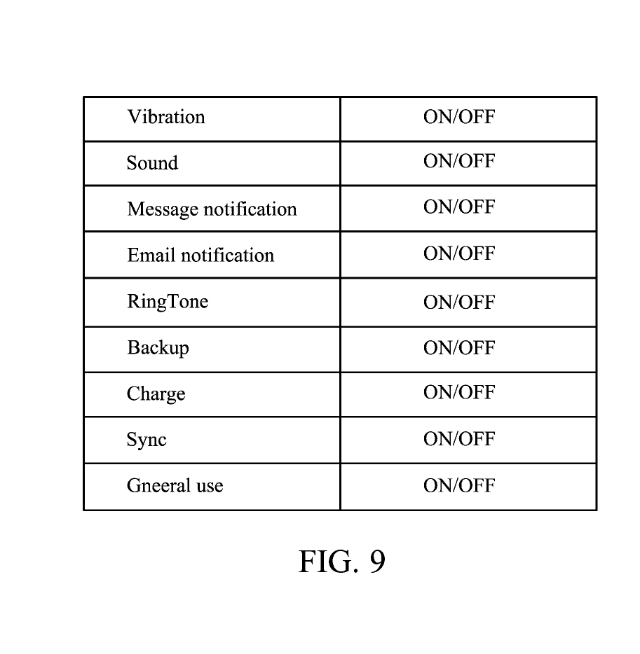

FIG. 9 is a schematic diagram of an operating mode setting according to an embodiment of the invention. The left column represents functions of the portable device, and the right column represents whether the function should be enabled. When the synchronization function is enabled, the portable device synchronizes a specific folder of the portable device with another folder of a computer or a backup server. When the backup function is enabled, the portable device backs up its data to a backup server or an external storage device when connecting to the dock. When the message notification function is enabled, a pop up window is shown when the portable device receives a message or a short message. When the charge function is enabled, the portable device is charged when connecting to the dock. When the general use function is enabled, the setting of the operating mode can be shared with other portable devices via the dock. In other words, the setting of the operating mode may be stored in the dock, and when another portable device is connected to the dock, the portable device first acquires the dock ID and checks whether the portable device has established a specific operating mode for the dock ID. If yes, the portable device changes it operating mode to the specific operating mode. If not, the portable device acquires and changes it setting according to the setting of operating mode from the dock.

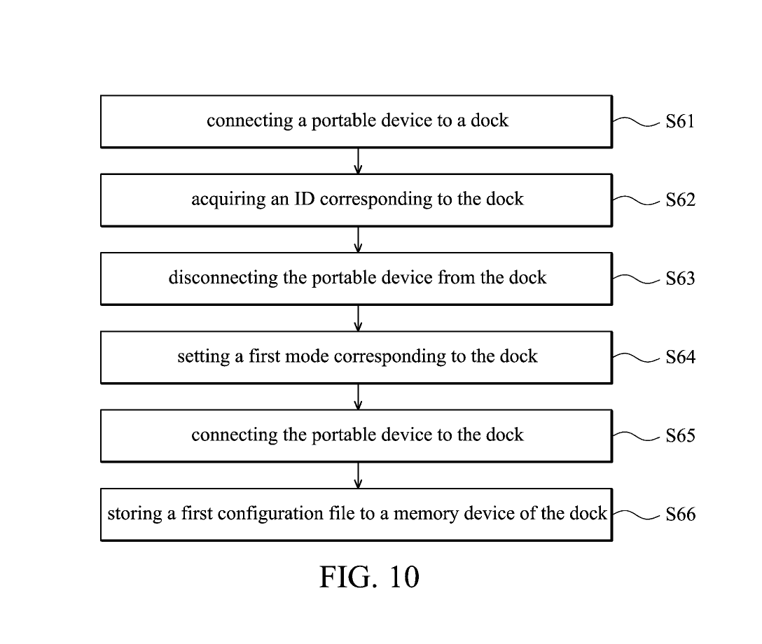

FIG. 10 is a flowchart of an operating mode setting method according to another embodiment of the invention. In step S61, the portable device is connected to the dock. In step S62, the portable device acquires an ID corresponding to the dock. In step S63, the portable device is disconnected from the dock. In step S64, user starts to set a first mode corresponding to the dock via a software interface. Then, the portable device generates a first configuration file according to the first mode and the ID. In step S65, the portable device reconnected to the dock. In the step S66, the portable device transmits and stores a first configuration file to a memory device of the dock. Once the portable device is connected to the dock, the portable device can directly acquire the first configuration file and change its setting according to the first configuration file. In another embodiment, when the portable device is connected to the dock, an application program is executed. The application program acquires the first configuration file and changes the setting of the portable device according to the first configuration file.

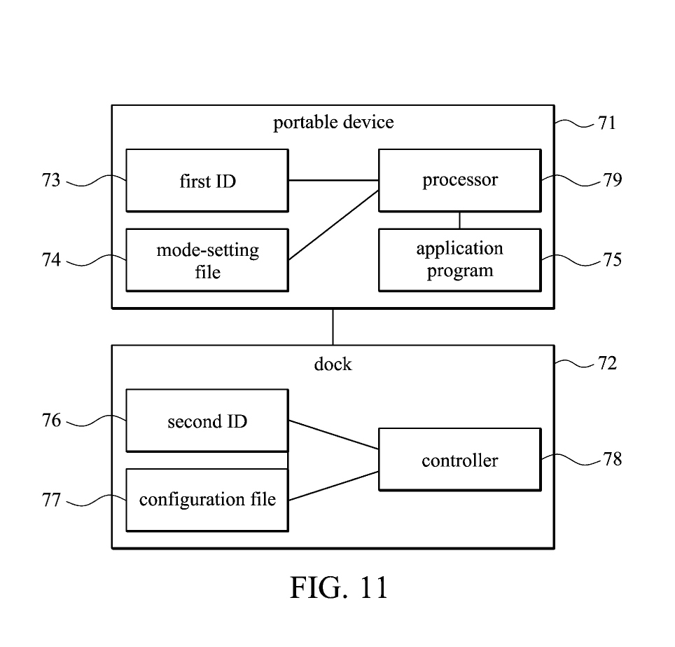

FIG. 11 is a block diagram showing an electronic system including a portable device and a dock according to another embodiment of the invention. When the portable device 71 is connected to the dock 72, the processor 79 acquires the second ID 76 and the controller 78 acquires the first ID 73 to determine whether the portable device 71 has ever been connected to the dock 72. If yes, the control of the portable device 71 is then transferred to the controller 78. The controller 78 reads a configuration file 77 to modify the mode-setting file 74 accordingly. Then, the control of the portable device 71 is transferred back to the processor 79. The processor 79 changes an operating mode of the portable device 71 according to the mode-setting file 74. In another embodiment, the controller 78 directly changes the operating mode of the portable device 71. The controller 78 first determines a type of a control instruction according to the first ID 73. Then, the controller 78 acquires the operating mode according to the second ID 76. The controller 78 then generates the control instruction according to both the first ID 73 and the second ID 76 and transmits the control instruction to the portable device 71 to change the operating mode of the portable device 71.

If the portable device 71 is connected to the dock 72 for a first time, the application program 75 is executed for setting at least one parameter of a specific mode corresponding to the dock 72. After the specific mode setting is completed, the application program 75 generates the configuration file 77 according to the second ID 76 and the specific mode. Once the portable device 71 is connected to the dock 72, the processor 79 first recognizes the dock 72 according to the second ID 76 and changes the operating mode according to the second ID 76.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An operating mode setting method for a portable device, comprising:
connecting the portable device to a dock;
acquiring an ID of the dock; and
changing an operating mode of the portable device to a first mode corresponding to the ID.

2. The method as claimed in claim 1, further comprising:
determining whether it is the first time that the portable device is connected to the dock; and
if it is the first time that the portable device is connected to the dock, setting, by the portable device, a plurality of parameters to create the first mode.

3. The method as claimed in claim 1, further comprising:
creating and storing a configuration file corresponding to the first mode to the dock; and
when the portable device is connected to the dock, acquiring, by the portable device, the configuration file to change the operating mode of the portable device.

4. A dock, comprising:
a connector for connection to a portable device; and
a memory device storing a dock ID, wherein when the portable device is connected to the dock, an application program is executed and changes a current operating mode of the portable device to a first mode according to the dock ID.

5. The dock as claimed in claim 4, further comprising a configuration file corresponding to the first mode, wherein when the portable device is connected to the dock, the portable acquires the configuration file to change the current operating mode of the portable device to the first mode.

6. The dock as claimed in claim 4, further comprising a controller and a charging module, wherein the charging module connects to an AC voltage source and transforms the AC voltage into a DC voltage.

7. The dock as claimed in claim 4, wherein the dock further comprises a storage medium and the data of the portable device is backed up in the storage medium.

8. The dock as claimed in claim 4, wherein the dock backs up the data of the portable device to a backup server via an internet network.

9. The dock as claimed in claim 4, wherein when the dock operates at the second mode, the control of the portable device is transferred to the dock.
